(19) United States
(12) Patent Application Publication
(10) Pub. No.: US 2010/0026655 A1
(43) Pub. Date: Feb. 4, 2010

(54) Capacitive Touchscreen or Touchpad for Finger or Stylus

(75) Inventor: Jonah A. Harley, Mountain View, CA (US)

Correspondence Address: Kathy Manke;Avago Technologies Limited, 4380 Ziegler Road, Fort Collins, CO, 80525, US

(73) Assignee: Avago Technologies ECBU IP (Singapore) Pte. Ltd.

(21) Appl. No.: 12/183,456

(22) Filed: Jul. 31, 2008

(51) Int. Cl. G06F 3/045

(52) U.S. Cl. 345/174

(57) ABSTRACT

According to one embodiment, there is provided a mutual capacitance touchscreen or touchpad having combined finger navigation and stylus navigation and/or character entry capabilities. First and second pluralities of sense and drive electrodes are disposed in or on upper and lower substrates. The sense and drive electrodes form an array disposed substantially in two opposing planes that are configured to permit at least one location corresponding to a finger or stylus placed in proximity thereto to be detected thereby. The upper substrate is deflectable towards the lower substrate when the stylus is pressed downwardly thereagainst.

### FIELD OF THE INVENTION

Various embodiments of the invention described herein relate to the field of capacitive sensing input devices generally, and more specifically to mutual capacitance measurement or sensing systems, devices, components and methods finding particularly efficacious applications in touchscreen and touchpad devices. Embodiments of the invention described herein include those amenable for use with a finger or stylus in portable or handheld devices such cell phones, MP3 players, personal computers, game controllers, laptop computers, PDA's and the like. Some of the embodiments disclosed herein may be configured or adapted for use in stationary applications such as in industrial controls, washing machines, exercise equipment, and the like.

### BACKGROUND

Resistive touchscreens and touchpads are known in the prior art, and often find application in touchscreens or touchpads that work in conjunction with a stylus. When the stylus is pressed downwardly against the touchscreen or touchpad, upper and lower resistive electrode arrays are brought into contact with one another and the location of the stylus is determined by calculating the location where the two arrays have shorted out. Resistive touchscreens typically attenuate light passing therethrough substantially owing to the relatively large amounts of Indium Tin Oxide (“ITO”) required to form the resistive electrode arrays thereof.

Capacitive touchscreens, such as those found in IPHONES™ provide two major advantages respecting resistive touchscreens. First, they function with almost no pressure being applied by a finger, so they do not present problems of stiction and are comfortable to use. This is particularly important for swipe and pinch gestures, where the finger has to slide over a touch surface. Second, some capacitive touchscreens support the measurement of multiple finger locations simultaneously (commonly known as “multi-touch” capability).

The primary technical drawback of a traditional capacitive touchscreen or touchpad is the lack of support for a stylus (in addition to a finger). A stylus provides a more precise pointing device, permits the entry of complicated text and characters, and does not obscure the target as much as a finger. Although capacitive touchscreens have been made to work with a stylus, it is believed this has only been accomplished with an electrically conductive stylus having a tip size comparable to that of a human finger. This, of course defeats the benefit of using a stylus.

What is needed is a capacitive touchscreen or touchpad that has the zero-force finger multi-touch navigation capabilities of a traditional capacitive touchscreen in combination with stylus character and text entry and navigation capabilities similar to those provided by resistive touchscreens. What is also needed is a capacitive finger and stylus touchscreen or touchpad that does not absorb or otherwise excessively impede the transmission of light therethrough, and that has a smaller footprint, volume or thickness.

Another important aspect of touchscreens and touchpads has to do with the particular type of technology employed in sensing and measuring changes in capacitance. Two principal capacitive sensing and measurement technologies currently find use in most touchpad and touchscreen devices. The first such technology is that of self-capacitance. Many devices manufactured by SYNAPTICS™ employ self-capacitance measurement techniques, as do integrated circuit (IC) devices such as the CYPRESS PSOC.™ Self-capacitance involves measuring the self-capacitance of a series of electrode pads using techniques such as those described in U.S. Pat. No. 5,543,588 to Bisset et al. entitled “Touch Pad Driven Handheld Computing Device” dated Aug. 6, 1996.

Self-capacitance is a measure of how much charge has accumulated on an object held at a given voltage (Q=CV). Self-capacitance is typically measured by applying a known voltage to an electrode, and then using a circuit to measure how much charge flows to that same electrode. When external grounded objects are brought close to the electrode, additional charge is attracted to the electrode. As a result, the self-capacitance of the electrode increases. Many touch sensors are configured such that the external grounded object is a finger. The human body is essentially a capacitor to ground, typically with a capacitance of around 100 pF.

Electrodes in self-capacitance touchpads are typically arranged in rows and columns. By scanning first rows and then columns the locations of individual disturbances induced by the presence of a finger, for example, can be determined. To effect accurate multi-touch measurements in a touchpad, however, it may be required that several finger touches be measured simultaneously. In such a case, row and column techniques for self-capacitance measurement can lead to inconclusive results. As a result, some prior art touchpad sensing systems suffer from a fundamental ambiguity respecting the actual positions of multiple objects placed simultaneously on or near the touchscreen.

One method of overcoming the foregoing problems in self-capacitance systems is to provide a system that does not employ a row and column scanning scheme, and that is instead configured to measure each touchpad electrode individually. Such a system is described in U.S. Patent Publication No. 2006/097991 to Hotelling et al. entitled “Multipoint touchscreen” dated May 11, 2006. In the touchpad sensing system disclosed in the foregoing patent publication to Hotelling, each electrode is connected to a pin of an integrated circuit (“IC”), either directly to a sense IC or via a multiplexer. As will become clear to those skilled in the art, however, individually wiring electrodes in such a system can add considerable cost to a self-capacitance system. For example, in an n×n grid of electrodes, the number of IC pins required is n². (The APPLE™ IPOD™ employs a similar capacitance measurement system.)

One way in which the number of electrodes can be reduced in a self-capacitance system is by interleaving the electrodes. Interleaving can create a larger region where a finger is sensed by two adjacent electrodes allowing better interpolation, and therefore fewer electrodes. Such patterns can be particularly effective in one dimensional sensors, such as those employed in IPOD clickwheels. See, for example, U.S. Pat. No. 6,879,930 to Sinclair et al. entitled “Capacitance touch slider” dated Apr. 12, 2005.

The second primary capacitive sensing and measurement technology employed in touchpad and touchscreen devices is that of mutual capacitance, where measurements are performed using a crossed grid of electrodes. See, for example, U.S. Pat. No. 5,861,875 to Gerpheide entitled “Methods and Apparatus for Data Input” dated Jan. 19, 1999 and above-referenced U.S. Patent Publication No. 2006/097991 to Hotelling et al. In mutual capacitance measurement, capacitance is measured between two conductors, as opposed to a self-capacitance measurement in which the capacitance of a single conductor is measured, and which may be affected by other objects in proximity thereto.

In some mutual capacitance measurement systems, an array of sense electrodes is disposed on a first side of a substrate and an array of drive electrodes is disposed on a second side of the substrate that opposes the first side; a column or row of electrodes in the drive electrode array is driven to a particular voltage, the mutual capacitance to a single row (or column) of the sense electrode array is measured, and the capacitance at a single row-column intersection is determined. By scanning all the rows and columns a map of capacitance measurements may be created for all the nodes in the grid. When a user's finger approaches a given grid point, some of the electric field lines emanating from or near the grid point are deflected, thereby typically decreasing the mutual capacitance of the two electrodes at the grid point. Because each measurement probes only a single grid intersection point, no measurement ambiguities arise with multiple touches as in the case of some self-capacitance systems. Moreover, to measure a grid of n×n intersections, only 2n pins on an IC are needed in such a system.

What is needed is a finger touch and stylus capacitive touchscreen that features the advantages of mutual capacitance technology and avoids the disadvantages and detractions of self-capacitance technology.

Further details concerning various aspects of some prior art devices and methods are set forth in: (1) U.S. Pat. No, 4,550,221 to Mabusth entitled “Touch Sensitive Control Device” dated Oct. 29, 1985; (2) U.S. Pat. No. 4,686,332 to Greanias entitled “Combined Finger Touch and Stylus Detection System for Use on the Viewing Surface of a Visual Display Device” dated Aug. 11, 1987; (3) U.S. Pat. No. 5,305,017 to Gerpheide entitled “Methods and Apparatus for Data Input” dated Apr. 19, 1994; (4) U.S. Pat. No. 5,844,506 to Binstead entitled “Multiple Input Proximity Detector and Touchpad System” dated Dec. 1, 1998; (5) U.S. Pat. No. 6,002,389 to Kasser entitled “Touch and Pressure Sensing Method and Apparatus” dated Dec. 14, 1999; (6) U.S. Pat. No. 6,097,991 to Hamel et al. entitled “Automatic Identification of Audio Bezel” dated Aug. 1, 2000: (7) U.S. Pat. No. 6,879,930 to Sinclair et al. entitled “Capacitance Touch Sensor” dated Apr. 12, 2005: (8) U.S. Pat. No. 7,202,859 to Speck et al. entitled “Capacitive Sensing Pattern” dated Apr. 10, 2007; and (9) U.S. Patent Publication No. 2006/0097991 A1 to Hotelling et al. entitled “Multipoint Touch-screen” dated May 11, 2006.

In addition, incorporated by reference herein in its entirety is U.S. patent application Ser. No. 12/024,057 filed Jan. 31, 2008 entitled “Single Layer Mutual Capacitance Sensing Systems, Devices, Components and Methods” to Jonah Harley et al. (hereafter “the '057 patent application”).

### SUMMARY

In one embodiment, there is a provided a mutual capacitance combined finger and stylus sensing touchscreen or touchpad comprising a lower substrate having a first plurality of electrodes disposed substantially in a first plane in rows or columns positioned thereupon or therein, the lower substrate being substantially rigid and inflexible, and an upper downwardly deflectable upper substrate located above the lower substrate and operatively configured in association therewith, the upper substrate having an upper touch surface forming a portion thereof or disposed thereover, the upper substrate further comprising a second plurality of electrodes disposed substantially in a second plane and in rows or columns positioned thereupon or therein, wherein the upper and lower substrates form opposing substantially planar and substantially parallel surfaces when the upper substrate is in a non-deflected position, the outer touch surface is configured for a user to place at least one finger or a stylus thereon and move the finger or the stylus thereacross, the first and second pluralities of electrodes form an electrode array configured to permit at least one location corresponding to the finger on the outer touch surface, or the stylus on the outer touch surface when the upper substrate is deflected downwardly towards the lower substrate by the stylus having a downward pressure applied thereto, to be detected by the array.

In another embodiment there is provided a method of sensing a position of a finger and a stylus on a touchscreen or touchpad comprising detecting the position of the finger on the touchscreen or touchpad when a mutual capacitance changes between a first plurality of electrodes and a second plurality of electrodes at the location corresponding to the finger, where the first and second pluralities of electrodes form an electrode array in the touchscreen or touchpad, and detecting the position of the stylus on the touchscreen when an upper portion of the touchscreen or touchpad is deflected downwardly by the stylus and the mutual capacitance changes between the first and second pluralities of electrodes at the location corresponding to the stylus.

In yet another embodiment, there is provided a method of making a mutual capacitance combined finger and stylus sensing touchscreen or touchpad comprising providing a lower substrate having a first plurality of electrodes disposed substantially in a first plane in rows or columns positioned thereupon or therein, the lower substrate being substantially rigid and inflexible, providing an upper downwardly deflectable upper substrate located above the lower substrate and operatively configured in association therewith, the upper substrate having an upper touch surface forming a portion thereof or disposed thereover, the upper substrate further comprising a second plurality of electrodes disposed substantially in a second plane and in rows or columns positioned thereupon or therein, forming the upper and lower substrates as opposing substantially planar and substantially parallel surfaces when the upper substrate is in a non-deflected position, configuring the rows or columns of the first plurality of electrodes substantially perpendicular to the rows or columns of the second plurality of electrodes, configuring the outer touch surface for a user to place at least one finger or a stylus thereon and move the finger or the stylus thereacross, and configuring the first and second pluralities of electrodes to form an electrode array configured to permit at least one location corresponding to the finger on the outer touch surface, or the stylus on the outer touch surface when the upper substrate is deflected downwardly towards the lower substrate by the stylus having a downward pressure applied thereto, to be detected by the array.

Further embodiments are disclosed herein or will become apparent to those skilled in the art after having read and understood the specification and drawings hereof.

### BRIEF DESCRIPTION OF THE DRAWINGS

Different aspects of the various embodiments of the invention will become apparent from the following specification, drawings and claims in which:

FIG. 1 shows a perspective view of a portion of one embodiment of a capacitive touchscreen or touchpad system 10 and corresponding electrode array 62 of the invention;

FIG. 2 shows a top plan view of the capacitive touchscreen or touchpad system 10 and corresponding electrode array 62 of FIG. 1;

FIG. 3 shows a cross-sectional view of one embodiment of capacitive touchscreen or touchpad system 10 with stylus 64 pressing downwardly on touchscreen surface 14 to deflect upper substrate 16 towards lower substrate 18;

FIG. 4 shows a capacitance measurement or sensing circuit 72 according to one embodiment of the invention, and

FIG. 5 shows a cross-sectional view of one embodiment of a touchscreen system of the invention.

The drawings are not necessarily to scale. Like numbers refer to like parts or steps throughout the drawings.

### DETAILED DESCRIPTIONS OF SOME PREFERRED EMBODIMENTS

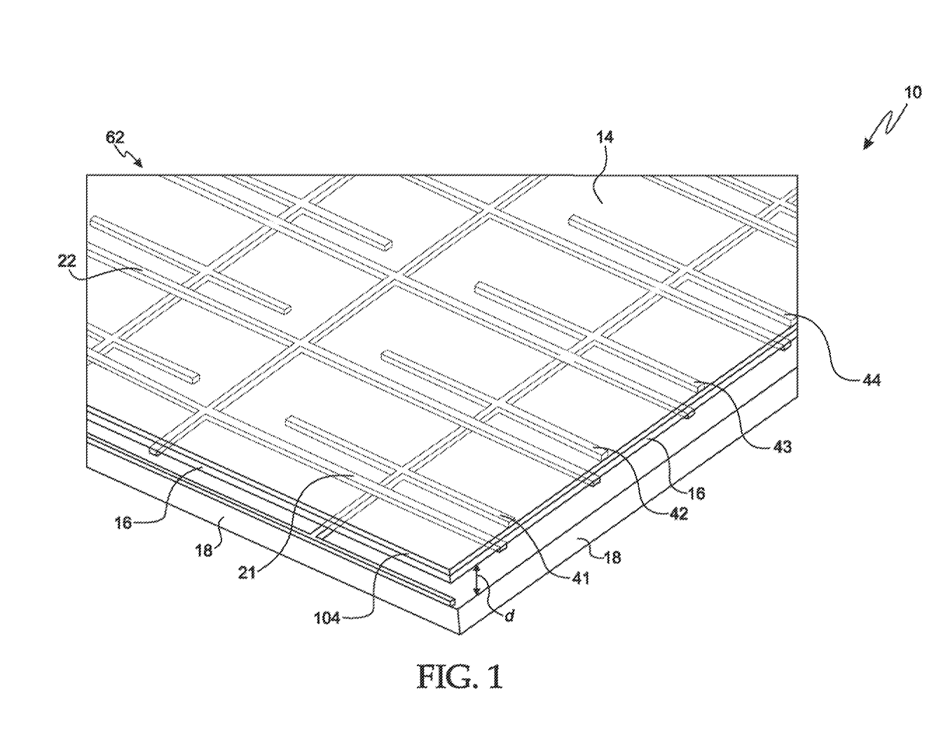

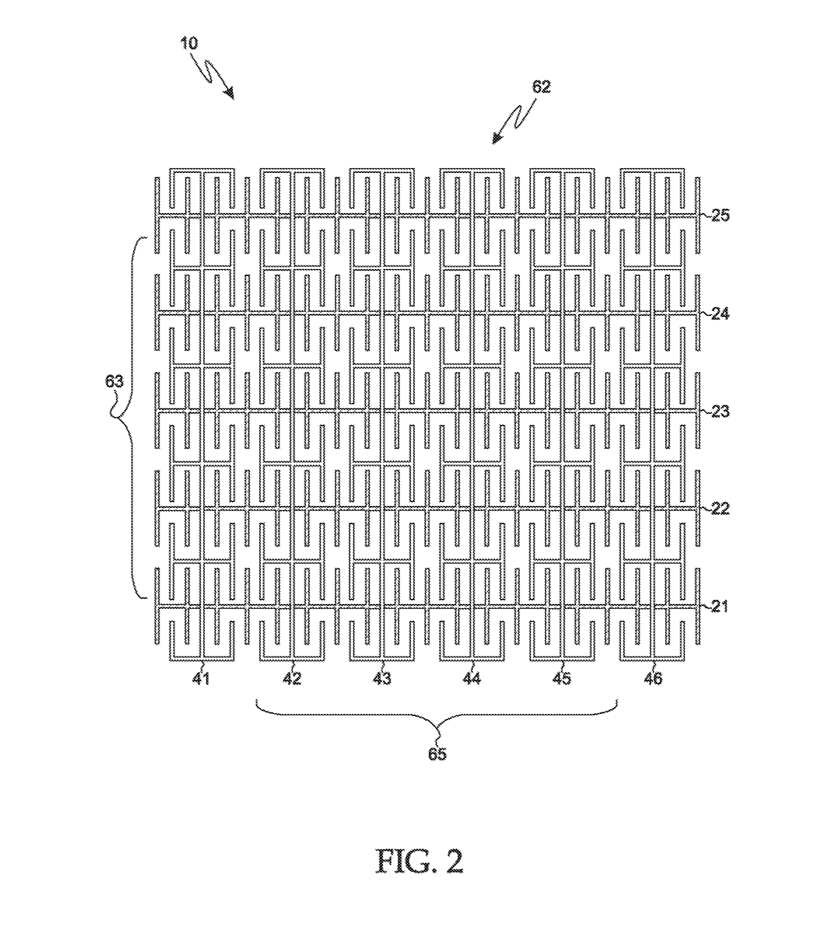

Referring to FIGS. 1 through 2, in some embodiments, there is provided a mutual capacitance touchscreen or touchpad having combined finger navigation and stylus navigation and character entry capabilities. First and second pluralities of sense and drive electrodes are disposed in or on upper and lower substrates. The sense and drive electrodes form an array disposed substantially in two opposing planes that are configured to permit at least one location corresponding to a finger or stylus placed in proximity thereto to be detected thereby. The upper substrate is deflectable towards the lower substrate when the stylus is pressed downwardly thereagainst.

Continuing to refer to FIGS. 1 through 3, a mutual-capacitance touchscreen or touchpad system may also be provided having sense and drive electrodes disposed in opposing first and second substantially parallel planes on upper and lower, or lower and upper, substrates. In some embodiments, electrode array 62 covers the display substantially uniformly, and therefore does not cause any grid patterns to be visible on a display or screen. Since sensing measurements are based on mutual capacitance, however, a row and column sensing configuration can be employed, which can be employed to reduce the pin count to only 2n for an n×n electrode grid. Furthermore, such an electrode array configuration is conducive to being arranged as interleaved fingers; which increases the ability to use interpolation techniques in determining a stylus or a user's finger location, and further reduces pin count requirements in respect of prior art mutual capacitance sensing or measurement systems.

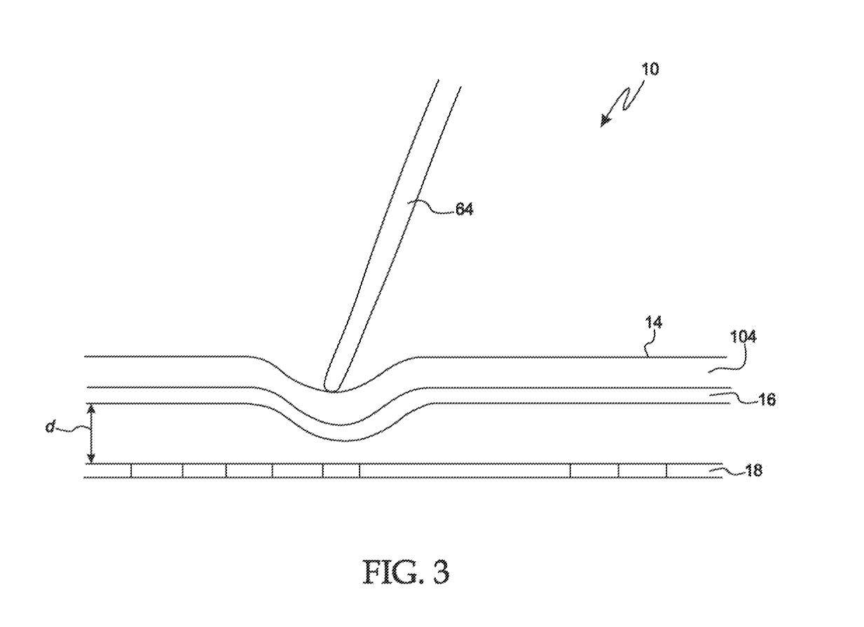

FIGS. 1 and 2 illustrate one embodiment of mutual capacitive sensing system 10 of the invention, where electrode array 62 is configured on upper substrate 16 as a first plurality of electrodes and on lower substrate 18 as a second plurality of electrodes. Spacing d of appropriate dimensions is disposed between upper substrate 16 and lower substrate 18 sufficient to permit upper substrate 16 to be deflected downwardly towards lower substrate 18 by a stylus 64 pressing thereagainst (see FIG. 3), and sensing of the stylus location. Representative dimensions for spacing d include, but are limited to distances ranging between about 50 microns and about 500 microns.

Continuing to refer to FIGS. 1 and 2, the spacings between rows or columns of first plurality of electrodes and the second plurality of electrodes most preferably ranges between about 1 mm and about 10 mm. The embodiments of system 10 illustrated in FIGS. 1 through 3 most preferably operate in accordance with the principles of mutual capacitance. Capacitances are established between individual sense and drive electrodes, e.g., electrodes 21-25 and 41-46, or between electrodes 41-46 and 21-25, as the case may be, by means of a drive waveform input to drive electrodes 21-25 or 41-46. A user's finger engages touch surface 14 of touch layer 104 (see FIGS. 1 and 3) that overlies array 62. In some embodiments, cover layer 104 is disposed over upper substrate 16 and between array 62 and the user's finger or stylus 64. In other embodiments (not shown in the drawings), upper substrate 16 alone is configured for the user's finger or stylus 64 to engage the top surface thereof and cover layer 104 is eliminated altogether.

When in light contact with or in close proximity to touch surface 14, the user's finger couples to the drive signal provided by a drive electrode in closest proximity thereto and proportionately generally reduces the amount of capacitance between such drive electrode and its corresponding nearby sense electrode. That is, as the user's finger moves across touch surface 14, the ratio of the drive signal coupled to the respective individual sense electrodes 41 through 46 through the finger is reduced and varied, thereby providing a two-dimensional measurement of a position of the user's finger above electrode array 62.

Note, however, that depending on the thickness of touch layer 104 and other factors, the capacitance between drive and sense electrodes can actually increase when a user's finger couples to the drive signal by being brought into proximity thereto. Thus, in the general case, it is more accurate to say that such capacitance changes when the user's finger is brought into proximity to the drive signal.

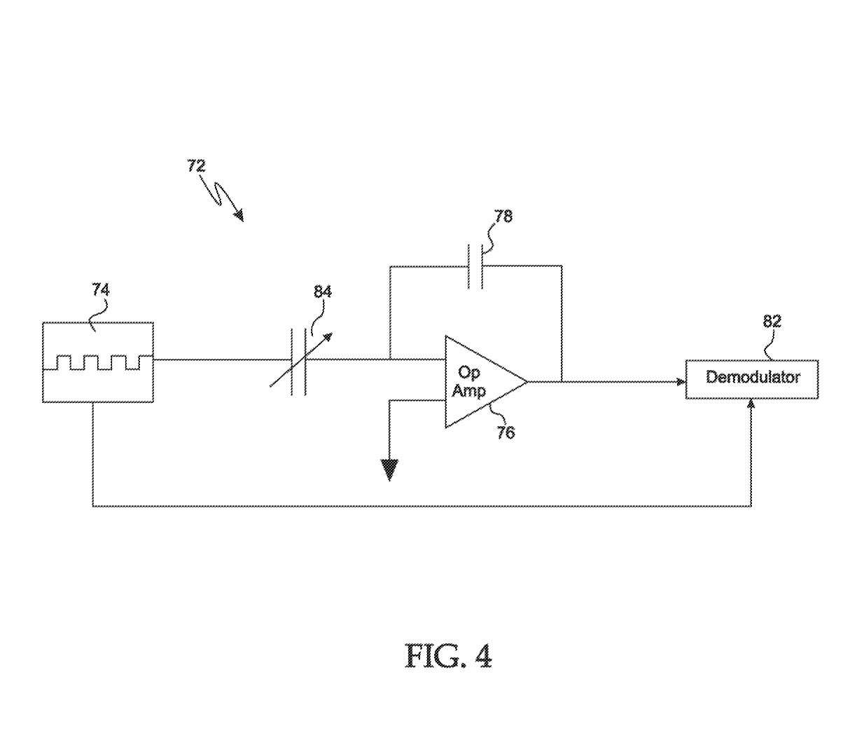

In such a manner, then, the capacitance at a single row-column intersection corresponding to the user's finger location is determined. By scanning all the rows and columns of array 62, a map of capacitance measurements may be created for all the nodes in the grid. Because each measurement probes only a single grid intersection point, no measurement ambiguities arise with multiple touches as in the case of some self-capacitance systems. Moreover, to measure a grid of n×n intersections, only 2n pins on an IC are required in system 10 illustrated in FIGS. 1 through 3. Thus, system 10 may be configured to scan rows 41-45 and 21-25 thereby to detect at least one location of the user's finger. System 10 may also be configured to multiplex signals provided by the rows and/or columns to a capacitance sensing circuit 72 (see, e.g., FIG. 4).

Note that either of the first and second pluralities of electrodes may be configured as drive or sense electrodes, and that such pluralities of electrodes may be configured as interleaved rows (as shown in FIGS. 1 and 2), as rows and columns that intersect one another in perpendicular fashion, or may assume any of a number of other electrode configurations known to those skilled in the art or disclosed in the above-referenced '057 patent application.

System 10 may be configured to sense multiple touch locations in electrode array 62 simultaneously or substantially simultaneously. In one embodiment a host computer is updated at a rate of for example, 60 Hz; all the rows and columns of array 62 are scanned sequentially to determine the position of any finger touches.

FIGS. 1 through 3 illustrate portions of one embodiment of mutual capacitance sensing system 10, where electrode array 62 is disposed on or in two opposing upper and lower substrates 16 and 18. In the illustrated embodiment, sense electrodes 41-46 are arranged in columns, and drive electrodes 21-25 are arranged in rows, although as mentioned above electrodes 41-46 may also be configured as drive electrodes and electrodes 21-25 may be configured as sense electrodes. Substrates 16 and 18 typically comprises glass, plastic, acrylic or any other suitable optically transparent material. Upper substrate 16 must be deflectable, and is preferably kept spaced apart from lower substrate 18 by portions of a compressible material such as silicone disposed therebetween. By way of example, during sensing electrode 21 is driven, and sense measurements are taken on all of electrodes 41-46. Next, drive electrode 22 is driven, followed by another series of sense measurements in sense electrodes 41-46.

In one embodiment, touch layer, cover glass or plastic layer 104 is disposed over electrode array 62, and is about 0.15 mm in thickness, and in preferred embodiments ranges between about 0.05 mm and about 0.5 mm in thickness. Electrode array 62 provides approximately a 0.25 pF change in capacitance upon a user's finger being brought into proximity thereto.

As shown in FIGS. 1 and 2, electrode array 62 exhibits good drive and sense electrode interaction and sensitivity because electrostatic field lines are concentrated at the borders between adjoining individual drive and sense electrodes. The overall signal produced by electrode array 62 is increased by interleaving portions of individual drive and sense electrodes 21-25 and 41-46. It will now become apparent to those skilled in the art that many different electrode interleaving and electrode array configurations other than those shown or described explicitly in the drawings or specification hereof may be employed and yet fall within the scope of the invention.

In one embodiment employing the principles described above respecting FIGS. 1 through 3, the values of the individual capacitances associated with sense electrodes 41 through 46 and drive electrodes 21 through 25 mounted on substrates 16 and 18, respectively, are monitored or measured by capacitance sensing circuit 72 (see, e.g. FIG. 4), as are the operating states of any additional switches that might be provided in conjunction therewith. In a preferred embodiment, a 125 kHz square wave drive signal is applied to drive electrodes 21 through 26 by capacitance sensing circuit 72 (see, e.g., FIG. 4) so that the drive signal is applied continuously to electrodes 21 through 25, although those skilled in the art will understand that other types of drive signals may be successfully employed. Indeed, the drive signal need not be supplied by capacitance sensing circuit 72, and in some embodiments is provided by a separate drive signal circuit. In a preferred embodiment, however, the drive signal circuit and the capacitance sensing circuit are incorporated into a single circuit or integrated circuit.

Electrode array 62 may include one or more ground traces disposed, for example, between individual drive electrode 21 and individual sense electrode 41 in a single sensing cell. Direct coupling of an electrical field between drive electrode 21 and sense electrode 41 is thereby reduced so that the majority of the coupling field lines in the electrical field may be interrupted by a finger or stylus instead of being drawn directly between electrodes 21 and 41, an effect which may become especially pronounced in the presence of humidity or water vapor. Such an embodiment also blocks short strong electrical fields from projecting through an overlying glass or plastic layer, thereby reducing unwanted capacitance in system 10. In other embodiments, no such ground trace is included in electrode array 62. Further details concerning the use of a ground conductor may be found in U.S. patent application Ser. No. 11/945,832 to Harley entitled “Capacitive Sensing Input Device with Reduced Sensitivity to Humidity and Condensation” filed on Nov. 27, 2007, the entirety of which is hereby incorporated by reference herein.

In preferred embodiments of the invention, a 0.15 mm thick plastic or glass touch spacer or cover layer 104 disposed above array 62 is sufficiently thick to ensure proper operation. Other thicknesses of layer 104 disposed between finger 60 and electrode array 62 may also be employed, such as between about 0.05 mm and about 0.5 mm.

FIG. 4 shows one embodiment of a circuit diagram for capacitive sensing or measurement system 10 of the invention. By way of example, an AVAGO™ AMRI-2000 integrated circuit may be employed to perform the functions of capacitance sensing circuit 72. A low-impedance AC waveform (e.g., a 100 kHz square wave) is provided to a drive electrode 21 (not shown in FIG. 15) by signal generator 74. Operational amplifier 76 with feedback capacitor 78 is connected to a sense electrode, and holds the sense line at virtual ground. Amplifier 76 acts as a charge to voltage converter, providing a voltage measurement of the charge induced through capacitor 78. Synchronous demodulation is effected by demodulator 82 and, with subsequent filtering, is used to extract low-frequency amplitude changes caused by changes in the sensed capacitance. Variable capacitor 84 indicates the mutual capacitance between drive and sense electrodes, as modulated by the presence of finger 60 (not shown in FIG. 15). Feedback capacitor 78 sets the gain of system 10. Those skilled in the art will appreciate that many circuits other than that shown in FIG. 15 may be employed to drive and sense electrode array 62 of the invention. One example of an integrated circuit that may be adapted to drive and sense signals provided by electrode array 62 is an AVAGO™ AMRI-2000 integrated circuit.

Output signals provided by electrode array 62 and circuit 72 are preferably routed to a host processor via, for example, a serial I²C-compatible or Serial Peripheral Interface (SPI) bus. For example, an AVAGO™ AMRI-2000 integrated circuit may be programmed to provide output signals to a host processor via such busses. The host processor may use information provided by the AMRI-2000 integrated circuit to control a display.

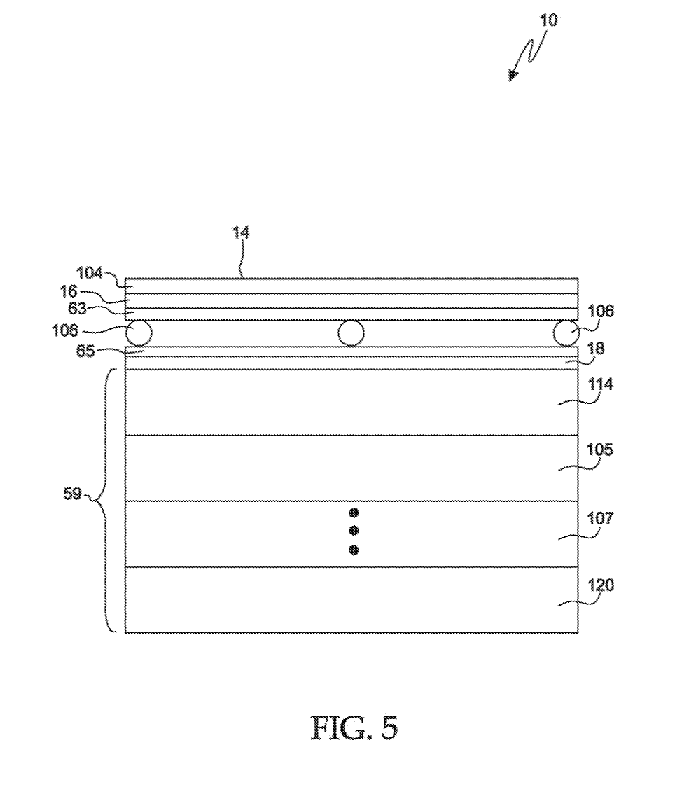

Referring now to FIG. 5, there is shown touchscreen device 10 generally representative of a type of touchscreen that may be employed in a mobile device. In system 10 of FIG. 5, cover glass layer 104 is disposed over upper substrate 16 which has indium tin oxide (ITO) rows 63 (which form a plurality of drive electrodes disposed in a plurality of rows) formed on the underside thereof, which are in turn are separated from ITO columns 65 (which form a plurality of sense electrodes disposed in a plurality of columns on lower substrate 18) by compressible touch sensor silicone balls 106. Liquid Crystal Display (LCD) portion 59 of touchscreen 10 shown in FIG. 5 comprises polarizer layer 114, front glass layer 105, layer 107 (described in greater detail below), and backlighting layer 120. Thus, a capacitive sensing electrode array 62 is formed by drive electrodes disposed in rows 63 on the lower surface of substrate 16 and sense electrodes disposed in columns 65 located on the upper surface of substrate 18. Compressible balls 106 are configured to permit upper substrate 16 to be deflected downwardly by a stylus towards lower substrate 18.

Continuing to refer to FIG. 5, polarizer layer 114 may be formed form multiple layers of plastic, adhesive and other materials FUJI FILM™ of Japan manufactures some the individual component layers of polarizer 114, while NITKO DENKO™ (also of Japan) assembles such individual layers into final polarizer layer products. Note that layer 107 may comprise any of a number of materials and devices required to render LCD portion 59 operable. Such devices and materials may include (or not include, as the particular case may be), but need not be limited to, one or a plurality of a retardation film, an alignment layer, spacers, liquid crystals and/or liquid crystal cells, a reflective film, a light scattering film, a protective layer, a color resist layer, a color filter, a glass substrate, a hard-coat material, a light guide, TFTs, an anti-reflective film, a film diffuser, a light guide plate, a transfer film, a WV film, a CV film, a ground layer, and electrical conductors or traces. Further details concerning the structure of LCD portion 59 are well known to those skilled in the art and therefore are not discussed in further detail herein.

Polarizer layer 114 may include any one or more of layers of triacetyl cellulose film (“TAC”), iodine, metal foil reflectors, protective film, polyvinyl alcohol (“PVA”), antireflection coatings, adhesives, optical retarders, glass, release film, and a grounding plane or layer. In addition, a glass layer typically included in a polarizer layer that is configured especially for use in many LCDs may serve as a substrate upon which rows of electrodes 63 and/or columns of electrodes 65 of array 62 may be formed.

While the primary use of capacitive sensing or measurement system 10 of the present invention is believed likely to be in the context of relatively small portable devices, and touchpads or touchscreens therefor, it may also be of value in the context of larger devices, including, for example, keyboards associated with desktop computers or other less portable devices such as exercise equipment, industrial control panels, washing machines and the like. Similarly, while many embodiments of the invention are believed most likely to be configured for manipulation by a user's fingers, some embodiments may also be configured for manipulation by other mechanisms or body parts. For example, the invention might be located on or in the hand rest of a keyboard and engaged by the heel of the user's hand. Furthermore, the invention is not limited in scope to drive electrodes disposed in columns and sense electrodes disposed in rows. Instead, rows and columns are interchangeable in respect of sense and drive electrodes.

Note further that included within the scope of the present invention are methods of making and having made the various components, devices and systems described herein.

The above-described embodiments should be considered as examples of the present invention, rather than as limiting the scope of the invention. In addition to the foregoing embodiments of the inventions review of the detailed description and accompanying drawings will show that there are other embodiments of the present invention. Accordingly, many combinations., permutations, variations and modifications of the foregoing embodiments of the present invention not set forth explicitly herein will nevertheless fall within the scope of the present invention.

We claim:

1. A mutual capacitance combined finger and stylus sensing touchscreen or touchpad, comprising:
a lower substrate having a first plurality of electrodes disposed substantially in a first plane in rows or columns positioned thereupon or therein, the lower substrate being substantially rigid and inflexible, and
an upper downwardly deflectable upper substrate located above the lower substrate and operatively configured in association therewith, the upper substrate having an upper touch surface forming a portion thereof or disposed thereover, the upper substrate further comprising a second plurality of electrodes disposed substantially in a second plane and in rows or columns positioned thereupon or therein;
wherein the upper and lower substrates form opposing substantially planar and substantially parallel surfaces when the upper substrate is in a non-deflected position, the outer touch surface is configured for a user to place at least one finger or a stylus thereon and move the finger or the stylus thereacross, the first and second pluralities of electrodes form an electrode array configured to permit at least one location corresponding to the finger on the outer touch surface, or the stylus on the outer touch surface when the upper substrate is deflected downwardly towards the lower substrate by the stylus having a downward pressure applied thereto, to be detected by the array.

2. The mutual capacitance touchscreen or touchpad of claim 1, wherein the rows or columns of the first plurality of electrodes are substantially perpendicular to the rows or columns of the second plurality of electrodes.

3. The mutual capacitance touchscreen or touchpad of claim 1, wherein the touchscreen or touchpad is configured such that a mutual capacitance between the first and second pluralities of electrodes changes at the location corresponding to the finger on the outer touch surface.

4. The mutual capacitance touchscreen or touchpad of claim 1, wherein the touchscreen or touchpad is configured such that a mutual capacitance between the first and second pluralities of electrodes changes at the location corresponding to the stylus on the outer touch surface when the upper substrate is deflected thereby.

5. The mutual capacitance touchscreen or touchpad of claim 1, wherein a spacing between rows or columns of at least one of the first plurality of electrodes and the second plurality of electrodes ranges between about 1 mm and about 10 mm.

6. The mutual capacitance touchscreen or touchpad of claim 1, wherein a spacing between the upper substrate and the lower substrate ranges between about 50 microns and about 500 microns.

7. The mutual capacitance touchscreen or touchpad of claim 1, wherein a compressible material is disposed between the upper substrate and the lower substrate thereby to permit at least portions of the upper substrate to be deflected downwardly by the stylus towards the lower substrate.

8. The mutual capacitance touchscreen or touchpad of claim 1, wherein the first plurality of electrodes are drive electrodes and the second plurality of electrodes are sense electrodes.

9. The mutual capacitance touchscreen or touchpad of claim 1, wherein the first plurality of electrodes are sense electrodes and the second plurality of electrodes are drive electrodes.

10. The mutual capacitance touchscreen or touchpad of claim 1, wherein at least one of the first and second pluralities of electrodes comprises indium tin oxide (ITO).

11. The mutual capacitance touchscreen or touchpad of claim 1, wherein at least one of the lower substrate and the upper substrate comprises at least one of glass, plastic and acrylic.

12. The mutual capacitance touchscreen or touchpad of claim 1, wherein at least one of the lower substrate and the upper substrate is substantially optically transparent.

13. The mutual capacitance touchscreen or touchpad of claim 1, further comprising a drive signal circuit configured to provide an electrical drive signal to one of the first and second pluralities of electrodes and operably connected thereto.

14. The mutual capacitance touchscreen or touchpad of claim 1, further comprising a capacitance sensing circuit operably coupled to the first and second pluralities of electrodes and configured to detect changes in capacitance occurring therein or thereabout.

15. The mutual capacitance touchscreen or touchpad of claim 1, further comprising at least one of a drive signal circuit and a capacitance sensing circuit operably connected to at least one of the first and second pluralities of electrodes.

16. The mutual capacitance touchscreen or touchpad of claim 18, wherein at least one of the drive signal circuit and the capacitance sensing circuit are incorporated into an integrated circuit.

17. The mutual capacitance touchscreen or touchpad of claim 1, further comprising at least one polarizer layer.

18. The mutual capacitance touchscreen or touchpad of claim 1, wherein the touchscreen or touchpad is incorporated into or forms a portion of an LCD, a computer display, a laptop computer, a personal data assistant (PDA), a mobile telephone, a radio, an MP3 player, a portable music player, a stationary device, a television, a stereo, an exercise machine, an industrial control, a control panel, an outdoor control device and a washing machine.

19. The mutual capacitance touchscreen or touchpad of claim 1, further comprising a touchscreen or touchpad controller configured to scan at least one of the rows and columns of the first and second pluralities of electrodes thereby to detect the at least one location of the finger or stylus.

20. The mutual capacitance touchscreen or touchpad of claim 1, wherein the touchscreen is configured to sense multiple touch or stylus locations in the array simultaneously.

21. A method of sensing a position of a finger and a stylus on a touchscreen or touchpad, comprising:
detecting the position of the finger on the touchscreen or touchpad when a mutual capacitance changes between a first plurality of electrodes and a second plurality of electrodes at the location corresponding to the finger, where the first and second pluralities of electrodes form an electrode array in the touchscreen or touchpad, and
detecting the position of the stylus on the touchscreen when an upper portion of the touchscreen or touchpad is deflected downwardly by the stylus and the mutual capacitance changes between the first and second pluralities of electrodes at the location corresponding to the stylus.

22. A method of making a mutual capacitance combined finger and stylus sensing touchscreen or touchpad, comprising:
providing a lower substrate having a first plurality of electrodes disposed substantially in a first plane in rows or columns positioned thereupon or therein, the lower substrate being substantially rigid and inflexible;
providing an upper downwardly deflectable upper substrate located above the lower substrate and operatively configured in association therewith, the upper substrate having an upper touch surface forming a portion thereof or disposed thereover, the upper substrate further comprising a second plurality of electrodes disposed substantially in a second plane and in rows or columns positioned thereupon or therein;
forming the upper and lower substrates as opposing substantially planar and substantially parallel surfaces when the upper substrate is in a non-deflected position;
configuring the rows or columns of the first plurality of electrodes substantially perpendicular to the rows or columns of the second plurality of electrodes;
configuring the outer touch surface for a user to place at least one finger or a stylus thereon and move the finger or the stylus thereacross, and
configuring the first and second pluralities of electrodes to form an electrode array configured to permit at least one location corresponding to the finger on the outer touch surface, or the stylus on the outer touch surface when the upper substrate is deflected downwardly towards the lower substrate by the stylus having a downward pressure applied thereto, to be detected by the array.

23. The method of claim 22, further wherein the touchscreen or touchpad is configured such that a mutual capacitance between the first and second pluralities of electrodes changes at the location corresponding to the finger on the outer touch surface.

24. The method of claim 22, wherein the touchscreen or touchpad is configured such that a mutual capacitance between the first and second pluralities of electrodes changes at the location corresponding to the stylus on the outer touch surface when the upper substrate is deflected thereby.
